(19) United States
(12) Patent Application Publication
(10) Pub. No.: US 2009/0242323 A1
(43) Pub. Date: Oct. 1, 2009

(54) Air duct as tuning mechanism and engine cover

(75) Inventors: Scott F. Densmore, Davison, MI (US); Mark L. Williams, Gaines, MI (US); Kenneth P. Tomaszewski, Riley, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/079,428

(22) Filed: Mar. 26, 2008

(51) Int. Cl. F02M 35/12

(52) U.S. Cl. 181/229

(57) ABSTRACT

A tuning device may include a tubular portion having a hollow cross section and a flat body portion covering an engine. The body portion may have a chamber disposed therein and a throat providing fluid communication between the chamber and the tubular portion. Air flowing through the tubular portion causes the chamber to produce interfering sound waves having a predetermined frequency. The interfering sound waves manipulate sound waves produced by the engine.

### FIELD

The present disclosure relates to an air induction system that functions as a tuning device and cover for an engine.

### BACKGROUND

The statements in this section merely provide background information related to the present disclosure and may not constitute prior art. The purchasing decisions of consumers of modern vehicles are increasingly influenced by the reality of a particular vehicle's emanation of noise that may be heard in a vehicle interior and exterior to the vehicle. Such noise, which may also be an indication of engine or overall vehicle quality, is generally generated from the vehicle's engine. Consumers may have different expectations of an acceptable level or degree of audible engine noise, which may vary based on vehicle class or category. For example, consumers may infer quality of sports cars and/or muscle cars from a louder, more distinctive sounding engine, which may indicate power and performance. To the contrary, consumers may infer quality of other types of vehicles, such as minivans and luxury vehicles, for example, from an engine that is quieter or not as loud as that in a sports car or pickup truck. Therefore, the sound, or a lack of sound, from a vehicle's engine may be a significant factor in the overall desirability or perceived quality of the vehicle.

In a similar manner, prospective purchasers of other products such as, for example, lawnmowers, generators, and compressors, may be similarly convinced of product quality by the sound of the engine powering such products. A consumer's enjoyment of the product and impressions of quality thereof may be influenced by a quieter engine or an engine that is tuned to emanate particular sounds or noise levels.

Conventional means of manipulating the sound of an internal combustion engine, such as by utilizing exhaust mufflers, may not adequately reduce noise from a user's point of reference. Further, exhaust mufflers that are more effective in attenuating noise often have an adverse affect on engine horsepower, overall engine performance and fuel economy. Other conventional sound manipulation means may be limited by packaging constraints within an engine compartment of the vehicle.

### SUMMARY

In one form, the present disclosure provides a tuning device that may include a tubular portion having a hollow cross section and a flat body portion that may completely or partially cover a top portion an engine. The body portion may have a chamber disposed therein and a throat providing fluid communication between the chamber and the tubular portion. Air flowing through the tubular portion causes the chamber to produce interfering sound waves having a predetermined frequency. The interfering sound waves manipulate sound waves produced by the engine.

The present disclosure also provides a tuning device that may have a body portion having a plurality of hollow chambers disposed therein, the body portion being a flat body covering an engine, the body portion being adapted to muffle, tune, or attenuate noise from an engine. A tubular portion may be in fluid communication with each of the plurality of hollow chambers via a plurality of throats. Air flowing through the tubular portion causes the plurality of hollow chambers to produce noise cancelling sound waves Each of a plurality of frequencies of the noise cancelling sound waves corresponds to noise frequencies produced by the engine.

The present disclosure also provides an air induction system for an engine that may include a throttle body for controlling air flow to the engine, an air duct fluidly connected to the throttle body and providing air flow thereto, and a resonator having a flat and hollow body portion and a tubular portion, the body portion having an upper shell, a lower shell and a plurality of walls disposed therein defining a plurality of chambers and a plurality of throats, the throats interconnecting the chambers with the tubular portion for fluid communication therebetween. Each of the chambers may have a volume corresponding to predetermined sound wave frequencies. The body portion may be an engine cover adapted to muffle or block sound emanating upward from the engine. Air flowing from the air duct through the tubular portion of the resonator produces pressure waves operable to reduce noise from an engine having an emanating predetermined sound wave frequencies into the surrounding environment.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial perspective view of a vehicle having an induction system according to the principles of the present disclosure;

FIG. 2 is an exploded view of the air induction system of FIG. 1;

FIG. 3 is a perspective view of the air induction system with an upper shell of a resonator removed according to the principles of the present disclosure;

FIG. 4 is a top view of a lower shell of the resonator according to the principles of the present disclosure;

FIG. 5 is a partial perspective view of the tubular portion of the resonator according to the principles of the present disclosure; and

FIG. 6 is a perspective view of the air induction system according to the principles of the present disclosure.

### DETAILED DESCRIPTION

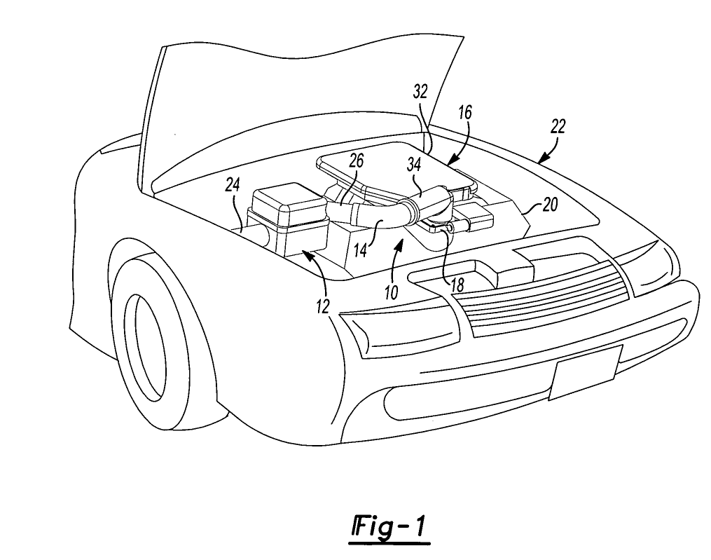

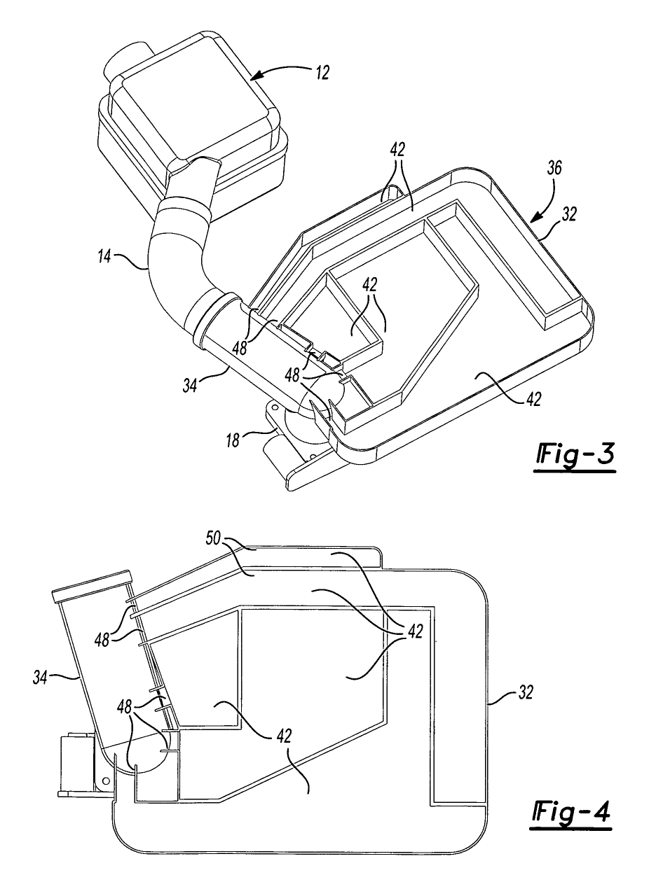

The following description is merely exemplary in nature and is not intended to limit the present disclosure, application, or uses. It should be understood that throughout the drawings, corresponding reference numerals indicate like or corresponding parts and features. With reference to FIGS. 1-6, an air induction system 10 is provided and may include an air cleaner 12, an air duct 14, a resonator assembly 16, and a throttle body 18. The throttle body 18 may be considered part of the engine 20. The air induction system 10 may provide air to an engine 20 for an air-fuel mixture for combustion within the engine 20. The engine 20 may be any type of internal combustion engine, and may be mounted to a vehicle 22, for example, to provide power for the vehicle. Alternatively, while the engine 20 is depicted in a vehicle 22, such as an automobile, the engine 20 may be used in other applications, such as mounted to other machines, such as a lawnmower, a generator, a compressor, or any other machine suitably powered by the engine 20. The resonator assembly 16 may be a sound tuning device operable to cancel and/or otherwise manipulate sound produced by the engine 20, as will be subsequently described.

The air cleaner 12 can be conventional in its construction and operation, and as such, it need not be discussed in great detail. That said, the air cleaner 12 may draw in ambient air through an inlet port 24, through a filtration means (not specifically shown) and through an outlet port 26 connected to the air duct 14. The filtration means is adapted to separate contaminants from the air to make the air suitable for combustion within the engine 20, as is well known in the art.

The air duct 14 may be a tubular member engaging the air cleaner 12 and the resonator assembly 16. The air duct 14 channels air from the air cleaner 12 to the resonator assembly 16 and the throttle body 18. The air duct 14 may be formed from a polymeric material, such as, for example, Nylon or any other suitable material.

The resonator assembly 16 may include a generally flat body portion 32 and a tubular portion 34. The body portion 32 may be formed from an upper shell 36, a lower shell 38, and one or more walls 40 defining one or more hollow chambers 42. The upper and lower shells 36, 38 may be injection molded or otherwise suitably formed from a polymer, such as, for example, nylon with a twenty percent (20%) mineral filler and a ten percent (10%) glass filler. It should be appreciated that the upper and lower shells 36, 38 could be formed from any material suitable to an engine compartment environment, including heat resistant materials, as the resonator assembly 16 may be disposed against or proximate to the engine 20 and/or other heat generating components. The one or more walls 40 may be integrally formed with the upper shell 36 or the lower shell 38.

The body portion 32 may be fixed to the engine 20 (or disposed proximately thereto). Additionally, the body portion 32 may be snap fit to rubber grommets protruding from the engine 20, thereby providing a clearance between the body portion 32 and the engine 20 to allow heat to dissipate from the engine 20. Accordingly, the body portion 32 may function as a as a partial top cover or a complete top cover for the engine 20. The advantage of the body portion 32 acting as a partial top cover or a complete top cover for the engine 20 is that sound and noise from the engine 20 can be attenuated, that is, blocked or muffled so that less noise reaches the interior compartment of the vehicle and the area surrounding the vehicle. Furthermore, the body portion 32 may include one or more apertures 43 to provide access to engine fluid reservoirs and/or dipsticks for oil, coolant, and/or other fluids (see FIG. 6).

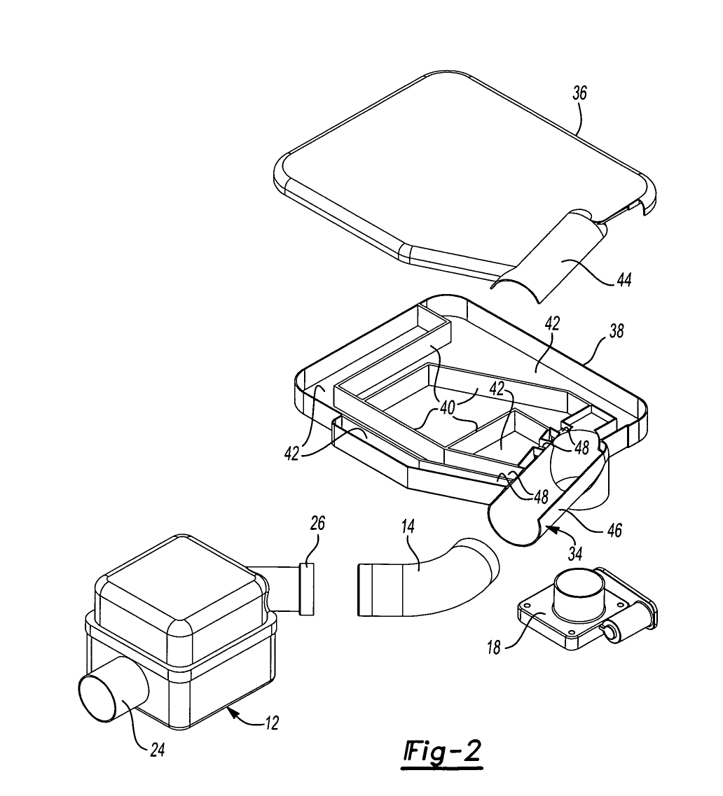

The tubular portion 34 may be a generally L-shaped tube and may fluidly interconnect the air duct 14 and the throttle body 18. The tubular portion 34 may be integrally formed with the body portion 32. For example, an upper section 44 of the tubular portion 34 may be integrally molded (or otherwise suitably formed) with the upper shell 36, and a lower section 46 of the tubular portion 34 may be integrally molded (or otherwise suitably formed) with the lower shell 38 (FIG. 2). The upper and lower shells 36, 38 may be vibration welded or otherwise suitably joined, thereby forming the body portion 32 and the tubular portion 34 as shown in FIGS. 1 and 6.

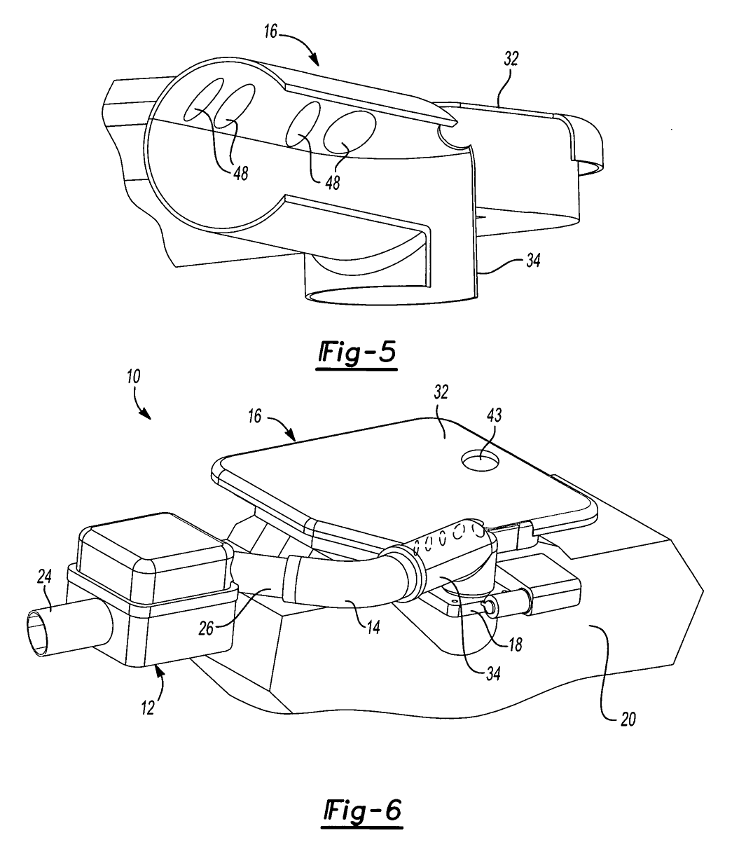

Each of the chambers 42 within the body portion 32 of the resonator assembly 16 may be in fluid communication with the tubular portion 34 via a throat 48. The throats 48 may have any suitable cross-sectional shape, including, for example, polygonal (FIGS. 2-4) or rounded (FIG. 5).

Although the tubular portion 34 is described above as being generally L-shaped, it should be appreciated that the tubular portion 34 may be otherwise configured depending on the positioning and/or configuration of the throttle body 18 relative to the air cleaner 12. It should also be appreciated that the air duct 14 could extend from the air cleaner 12 to the throttle body 18, such that the tubular portion 34 could be integrally formed with the air duct 14, rather than the body portion 32 as described above. In this configuration, the body portion 32 of the resonator assembly 16 could be attached to the air duct 14 such that the throats 48 may be aligned with apertures in the air duct 14, thereby providing fluid communication between the air duct 14 and the chambers 42. Alternatively, the tubular portion 34 could be formed separately from the body portion 32 and the air duct 14 and may be subsequently sealed thereto for fluid communication therebetween.

The throttle body 18 can be conventional in its construction and operation, and as such, it need not be discussed in great detail. As such, the throttle body 18 may be connected to the tubular portion 34 (or the air duct 14) and receive air therefrom. The throttle body 18 regulates the flow of the air to the engine 20, thereby controlling the speed of the engine 20, as is well known in the art.

With continued reference to FIGS. 1-6, the operation of the air induction system 10 will be further described. The engine 20 draws air through the air cleaner 12, the air duct 14, the tubular portion 34, and the throttle body 18 to be subsequently mixed with fuel. Air flowing through the tubular portion 34 creates sound waves at predetermined frequencies through a phenomenon known as Helmholtz resonance, as will be subsequently described. The sound waves produced by the resonator assembly 16 may be utilized or directed to manipulate sound waves produced by the engine 20 and/or intake and exhaust systems of the engine 20.

Air flowing through or across the throats 48 creates a pressure differential, which forces air into the chambers 42, which subsequently increases the air pressure within the chambers 42. High pressure within the chambers 42 causes the air therein to flow back out of the chambers 42 in an attempt to reach equilibrium. However, due to the momentum of the air flowing through the throats 48, more air flows out of the chambers 42 than is required to reach equilibrium, resulting in low air pressure in the chambers 42. This low air pressure in the chambers 42 then draws in more air from the tubular portion 34, resulting in high pressure within the chambers 42. This process repeats and causes air to rush in and out of the chambers 42 in a cyclical or spring-like fashion and in so doing produces pressure waves (sound waves) at a frequency based on the geometry of the chambers 42 and the throats 48.

The frequency of the sound waves produced by a particular one of the chambers 42 of the resonator assembly 16 can be determined from the following equation:

$$f = \frac{c}{2 π} \sqrt{\frac{A}{V L}} ,$$

where f is the frequency, c is the speed of sound in air, A is the cross-sectional area of the throat 48, V is the volume of the chamber 42, and L is the length of the throat 48. Accordingly, the larger the volume of a particular chamber 42, the lower the frequency that will be will be produced by the particular chamber 42. Conversely, the smaller the volume of a particular chamber 42, the higher the frequency produced.

The resonator assembly 16 may be formed or constructed such that each of the plurality of chambers 42 has a volume that is tuned to a produce a particular frequency. The sound waves produced by the resonator assembly 16 may be tuned to constructively or destructively interfere with sound waves produced as or as a result of engine noise. In this manner, the resonator assembly 16 may be configured to change the sounds or noise heard by a person for sounds or noise coming from the engine 20. For example, the resonator assembly 16 could be configured to give the engine 20 a rumbling or “throaty” sound, as may be desired for an engine in a sports car or performance sedan. Additionally or alternatively, the resonator assembly 16 may be configured to reduce engine noise by destructively interfering with sound waves emanating from the throttle body 18, thereby cancelling noise within a particular band of frequencies. In short, particular noise or sounds (audible frequencies) that are generated by the engine 20 may find their way into the throttle body 18 and exit or attempt to exit from the throttle body 18. The resonator assembly 16 generates frequencies, many that are the same as that in the throttle body 18, that destructively interfere with the frequencies in or passing through the throttle body 18 from the engine. As a result, less noise or sounds are heard inside the passenger compartment or exterior to the vehicle 22.

The chambers 42 may be shaped substantially as depicted in FIGS. 2-4. One or more of the chambers 42 may be quarter wave resonators 50 which may be adapted to cancel narrow bands of high frequency sound depending on the length of the quarter wave resonator 50. It should be appreciated that the chambers 42 could otherwise be shaped depending on the desired sound wave frequency bands to be manipulated and packaging constraints within the vehicle 22, for example.

As described above, the resonator assembly 16 may cover the engine 20 to provide protection therefor and/or to provide aesthetic qualities to the engine 20 and the engine compartment of the vehicle 22. As a cover, the resonator assembly may protect the engine from moisture, such as water or debris. Considering this aspect of the teachings, the air induction system 10 may serve as a conventional engine cover and as a resonator or frequency generator, as described.

Additionally or alternatively, the resonator assembly 16 may have a further sound attenuating member mounted thereto and disposed between the lower shell 38 and the engine 20. The sound attenuating member could be formed from urethane foam or any other suitable sound absorbent material that is capable of withstanding any heat and vibration from the engine compartment. The sound attenuating member may absorb sound emanating from the engine 20, thereby supplementing the noise cancellation function of the resonator assembly 16. It should be appreciated that the body portion 32 may sufficiently muffle sound from the engine 20 without the sound attenuating member.

In addition to the disclosure as described above, a tuning device may employ a tubular portion 34 having a hollow cross section, and a flat body portion 32 covering an engine 20. The body portion 32 may have a chamber 42 disposed therein and a throat 48 providing fluid communication between the chamber 42 and the tubular portion 34. Air flowing through the tubular portion 34 may cause the chamber 42 to produce interfering sound waves having a predetermined frequency (Hz). The interfering sound waves may then manipulate, cancel, or interfere with sound waves produced by the engine 20 as communicated through a throttle body 18. The interfering sound waves are operable to reduce engine noise. A plurality of chambers 42 and a plurality of throats 48 may exist in either of both of the upper shell 36 and lower shell 38. A volume of each of the plurality of chambers 42 corresponds to one or more predetermined sound wave frequencies. Air flowing through the tubular portion 34 produces sound waves having a plurality of frequencies adapted to cancel noise including a plurality of predetermined sound wave frequencies. The body portion 32 and the tubular portion 34 may be integrally formed. The tubular portion 34 may be attached to an air duct 14 and a throttle body 18 for fluid communication therebetween. The body portion 32 muffles sound produced by the engine 20. The body portion 32 includes an upper shell 36 and a lower shell 38 joined together. The interfering sound waves are produced by air drawn by the engine 20. The flat body portion 32 itself physically prevents engine noise from radiating upwardly as it acts as a physical barrier to noise, in addition to is noise canceling abilities as described above.

In another example, a tuning device may employ a body portion 32 having a plurality of hollow chambers 42 disposed therein, the body portion 32 being a flat body, or at least having a flat top, covering an engine 20. The body portion 32 may be situated or positioned to muffle noise radiating upwardly from the engine 20. A tubular portion 34 may be in fluid communication with the plurality of hollow chambers 42 via a plurality of throats 48. The air flowing through the tubular portion 34 causes the plurality of hollow chambers 42 to produce noise cancelling sound waves having a plurality of frequencies. Each of a plurality of frequencies of the noise cancelling sound waves corresponds to sound frequencies produced by the engine 20. At least one of the chambers 42 is a quarter wave resonator. The throats 48 may have a round cross section or a polygonal cross section. The body portion 32 and the tubular portion 34 may be integrally formed from a heat resistant polymer.

In yet another example, an air induction system for an engine 20 may employ a throttle body 18 to control the flow of air to the engine 20. An air duct 14 may fluidly connect to the throttle body 18 and provide air flow thereto. A resonator may have a flat and hollow body portion 32 and a tubular portion 34. The body portion 32 may have an upper shell 36, a lower shell 38 and a plurality of walls 40 disposed therein and defining a plurality of chambers 42 and a plurality of throats 48. The throats 48 may interconnect the chambers 42 with the tubular portion 34 for fluid communication therebetween. Each of the chambers 42 may have a volume corresponding to predetermined sound wave frequencies. The body portion 32 is an engine cover adapted to muffle sound emanating from the engine 20. Air flowing from the air duct 14 through the tubular portion 34 of the resonator assembly 16 produces pressure waves operable to reduce noise from a running engine 20 having predetermined sound wave frequencies. The noise from the engine 20 may be transmitted through the throttle body 18 and meet the frequencies generated by resonator 16, and more specifically, the throats 48, chambers 48, and walls 40 of the resonator 16. The resonator 16 may be formed from a heat resistant material. The heat resistant material may be nylon having glass filler and mineral filler. The throats 48 may have a round cross section or a polygonal cross section.

The resonator assembly 16 performs the multiple functions described above such as providing sound cancellation of a plurality of frequency bands, providing sound absorption, and providing an aesthetically pleasing partial or total cover for the engine 20, that protects the engine 20 from environmental elements such as rain and dirt. Such a cover maximizes available space in the engine compartment of the vehicle 22.

What is claimed is:

1. A tuning device comprising:
a tubular portion having a hollow cross section; and
a flat body portion covering an engine, the body portion having a chamber disposed therein and a throat providing fluid communication between the chamber and the tubular portion,
wherein air flowing through the tubular portion causes the chamber to produce interfering sound waves having a predetermined frequency, the interfering sound waves manipulate sound waves produced by an engine.

2. The tuning device according to claim 1, wherein the interfering sound waves are operable to reduce engine noise.

3. The tuning device according to claim 1, further comprising a plurality of chambers, and a plurality of throats.

4. The tuning device according to claim 3, wherein a volume of each of the plurality of chambers corresponds to predetermined sound wave frequencies.

5. The tuning device according to claim 3, wherein air flowing through the tubular portion produces sound waves having a plurality of frequencies adapted to cancel noise including a plurality of predetermined sound wave frequencies.

6. The tuning device according to claim 1, wherein the body portion and the tubular portion are integrally formed.

7. The tuning device according to claim 1, wherein the tubular portion is attached to an air duct and a throttle body for fluid communication therebetween.

8. The tuning device according to claim 1, wherein the body portion muffles sound produced by the engine.

9. The tuning device according to claim 1, wherein the body portion includes an upper shell and a lower shell joined together.

10. The tuning device according to claim 1, wherein the interfering sound waves are produced by air drawn by the engine.

11. The tuning device according to claim 1, wherein the flat body portion itself physically prevents engine noise from radiating upwardly.

12. A tuning device comprising:
a body portion having a plurality of hollow chambers disposed therein, the body portion being a flat body covering an engine, the body portion being adapted to muffle noise from the engine; and
a tubular portion in fluid communication with the plurality of hollow chambers via a plurality of throats,
wherein air flowing through the tubular portion causes the plurality of hollow chambers to produce noise cancelling sound waves having a plurality of frequencies, each of a plurality of frequencies of the noise cancelling sound waves corresponds to sound frequencies produced by the engine.

13. The tuning device according to claim 13, wherein at least one of the chambers is a quarter wave resonator.

14. The tuning device according to claim 13, wherein the throats have a round cross section.

15. The tuning device according to claim 13, wherein the throats have a polygonal cross section.

16. The tuning device according to claim 13, wherein the body portion and the tubular portion are integrally formed from a heat resistant polymer.

17. An air induction system for an engine comprising:
a throttle body controlling air flow to the engine;
an air duct fluidly connected to the throttle body and providing air flow thereto; and
a resonator having a flat and hollow body portion and a tubular portion, the body portion having an upper shell, a lower shell and a plurality of walls disposed therein defining a plurality of chambers and a plurality of throats, the throats interconnecting the chambers with the tubular portion for fluid communication therebetween, each of the chambers having a volume corresponding to predetermined sound wave frequencies,
wherein the body portion is an engine cover adapted to muffle sound emanating from the engine, and air flowing from the air duct through the tubular portion of the resonator produces pressure waves operable to reduce noise from an engine having predetermined sound wave frequencies.

18. The air induction system for an engine according to claim 17, wherein the resonator is formed from a heat resistant material.

19. The air induction system for an engine according to claim 18, wherein the heat resistant material is nylon having glass filler and mineral filler.

20. The air induction system for an engine according to claim 17, wherein the throats have a round cross section.

21. The air induction system for an engine according to claim 17, wherein the throats have a polygonal cross section.
